(19) United States
(12) Patent Application Publication
(10) Pub. No.: US 2017/0010690 A1
(43) Pub. Date: Jan. 12, 2017

(54) TERMINAL AND METHOD OF OPERATING TERMINAL

(71) Applicant: WideVantage Inc., Seoul (KR)

(72) Inventor: Jae Yong KOH, Seoul (KR)

(73) Assignee: WIDEVANTAGE INC., Seoul (KR)

(21) Appl. No.: 14/937,073

(22) Filed: Nov. 10, 2015

(30) Foreign Application Priority Data
Jul. 7, 2015 (KR) 1020150096849
Oct. 18, 2015 (KR) 1020150145032
Oct. 30, 2015 (KR) 1020150152361

(51) Int. Cl. G06F 3/0346; G06F 3/0481; G06F 3/038; G06F 3/0488; H04W 52/02; G06F 3/041

(52) U.S. Cl. CPC G06F 3/0346; H04W 52/0254; G06F 3/0414; G06F 3/0383; G06F 3/04883; G06F 3/04812; G06F 2203/04801

(57) ABSTRACT

A terminal is disclosed. At least one of content display and power saving for the terminal may be controlled based on a location of an object and a direction indicated by the object.

### CROSS-REFERENCE TO RELATED APPLICATION(S)

This application claims the benefit under 35 USC 119(a) of Korean Patent Application No. 10-2015-0096849 filed on Jul. 7, 2015, Korean Patent Application No. 10-2015-0145032 filed on Oct. 18, 2015, and Korean Patent Application No. 10-2015-0152361 filed on Oct. 30, 2015 in the Korean Intellectual Property Office, the entire disclosure of which is incorporated herein by reference for all purposes.

### BACKGROUND OF THE INVENTION

1. Field of the Invention

The following description relates to a terminal and an operating method of the terminal.

2. Description of the Related Art

Recently, the size and the weight of a terminal such as a smartphone have been smaller and lighter due to development of a low-power circuit and an algorithm. In addition, various contents have been developed, and the contents may be implemented in the terminal.

Due to a smaller size of a battery along with the smaller size of the terminal and an increase in implementation of contents, power conservation may be necessary for the terminal. In related arts, a terminal may determine whether a user views the terminal through a camera, and enter a power saving mode in response to a determination that the user does not view the terminal. However, a great amount of power may be used for using the camera and determining whether the user views the terminal.

### SUMMARY OF THE INVENTION

According to an aspect of the present invention, there is provided a terminal including a processor configured to control at least one of content display and power saving for the terminal based on a location of an object and a direction indicated by the object.

The terminal may further include a first sensor configured to measure a magnetic field value corresponding to a location and a direction of a magnetic field generator based on a magnetic field generated from the magnetic field generator corresponding to the object. The processor may control at least one of the content display and the power saving based on the magnetic field value.

The object may include a physical portion, and the terminal may further include a second sensor configured to sense a location of the physical portion and a direction indicated by the physical portion. The processor may verify whether the physical portion moves towards the terminal or views (or looks at) the terminal based on the location of the physical portion and the direction indicated by the physical portion, and control at least one of the content display and the power saving based on the verifying.

The terminal may further include a communicator configured to receive the location and the direction from the object, and the processor may control at least one of the content display and the power saving based on the received location and the received direction.

The processor may determine a target area of a content displayed on a display of the terminal based on at least one of the location and the direction.

The processor may expose a subsequent layer of a displayed layer of the target area based on the determining of the target area.

A form of the target area may be determined based on a volume corresponding to the object.

When the target area of the content is determined based on at least one of the location and the direction, the object moves towards the terminal, and a distance between the object and the terminal is within a preset range, the processor may expose a subsequent layer located under a displayed layer of the target area.

The processor may control an exposure of the target area determined based on at least one of the location and the direction and on the volume preset to correspond to the object.

The processor may determine the target area of the content based on at least one of the location and the direction, and control a visual feedback on the content to correspond to a moving direction of the object based on a selection input for the target area.

The processor may expose a visual feedback of pushing the content in response to the object coming closer to the terminal after the target area is selected, and expose a visual feedback of pulling the content in response to the object being separated further from the terminal after the target area is selected.

In response to occurrence of a touch event based on a contact between the object and the terminal, the processor may determine a lighting target area and a lighting direction of the content based on a location at which the touch event occurs and an inclination angle of the object towards the terminal.

In response to occurrence of a touch event based on a contact between the object and the terminal, the processor may control an exposure of a layer of the content displayed on the display using information about a pressure of the touch event.

The processor may verify a relative location between the object and the terminal using the location, and enter a power saving mode in response to the relative location being out of a preset range.

The processor may verify an inclination direction of the object towards the terminal, and enter the power saving mode based on the inclination direction.

The processor may enter the power saving mode based on a magnetic field value changing pattern.

When a degree of freedom (DoF) corresponding to the location has a preset limit, the processor may determine a direction corresponding to an inclination of the object in a space using the magnetic field value.

According to another aspect of the present invention, there is provided an operating method of a terminal, including controlling at least one of content display and power saving based on a location of an object and a direction indicated by the object.

The operating method may further include measuring a magnetic field value corresponding to a location and a direction of a magnetic field generator based on a magnetic field generated from the magnetic field generator corresponding to the object. The controlling may include controlling at least one of the content display and the power saving based on the magnetic field value.

The object may include a physical portion, and the operating method may further include verifying whether the physical portion moves towards the terminal or views (or looks at) the terminal based on a location of the physical portion and a direction indicated by the physical portion, and controlling at least one of the content display and the power saving based on the verifying.

The controlling may include determining a target area of a content displayed on a display of the terminal based on at least one of the location and the direction, and exposing a subsequent layer of a displayed layer of the target area based on the determining of the target area.

The controlling may include controlling an exposure of the target area determined based on at least one of the location and the direction and on a volume preset to correspond to the object.

The controlling may include determining the target area of the content based on at least one of the location and the direction, and controlling a visual feedback on the content to correspond to a moving direction of the object based on a selection input for the target area.

The controlling of the visual feedback on the content may include exposing a visual feedback of pushing the content in response to the object coming closer to the terminal after the target area is selected, and exposing a visual feedback of pulling the content in response to the object being separated farther from the terminal after the target area is selected.

In response to occurrence of a touch event based on a contact between the object and the terminal, the controlling may include determining a lighting target area and a lighting direction of the content based on a location at which the touch event occurs and an inclination angle of the object towards the terminal.

In response to occurrence of a touch event based on a contact between the object and the terminal, the controlling may include controlling an exposure of a layer of the content displayed on the display using information about a pressure of the touch event.

The controlling may include verifying a distance between the object and the terminal based on the location, and entering a power saving mode in response to the distance being out of a preset range.

When a DoF corresponding to the location is preset, the controlling of at least one of the content display and power saving based on the magnetic field value may include determining a direction corresponding to an inclination of the object in a space using the magnetic field value.

### BRIEF DESCRIPTION OF THE DRAWING

FIG. 1 is a diagram illustrating a terminal and a user input device according to an embodiment.

FIGS. 2 through 6 are diagrams illustrating examples of a process of controlling content display according to an embodiment.

FIGS. 7 through 9 are diagrams illustrating other examples of a process of controlling content display according to an embodiment.

FIG. 10 is a block diagram illustrating a terminal according to an embodiment.

FIG. 11 is a flowchart illustrating an operating method of a terminal according to an embodiment.

FIG. 12 is a diagram illustrating an example of an operating method of a terminal according to an embodiment.

FIG. 13 is a diagram illustrating another example of an operating method of a is terminal according to an embodiment.

### DETAILED DESCRIPTION OF EMBODIMENTS

Hereinafter, example embodiments will be described in detail with reference to the accompanying drawings.

Various changes and modifications may be made to example embodiments to be described hereinafter. It should be understood that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular examples only and is not to limit the examples. As used herein, the singular forms “a,” “an,” and “the” are intended to include the plural forms as well, unless the context clearly indicates otherwise. As used herein, the terms “comprises,” “comprising,” “includes,” “including,” “has,” and “having” specify the presence of stated features, numbers, operations, elements, components, and combinations thereof, but do not preclude the presence or addition of one or more other features, numbers, operations, elements, components, and combinations thereof.

Unless otherwise defined, all terms including technical and scientific terms used herein have the same meaning as commonly understood by one of ordinary skill in the art to which these example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

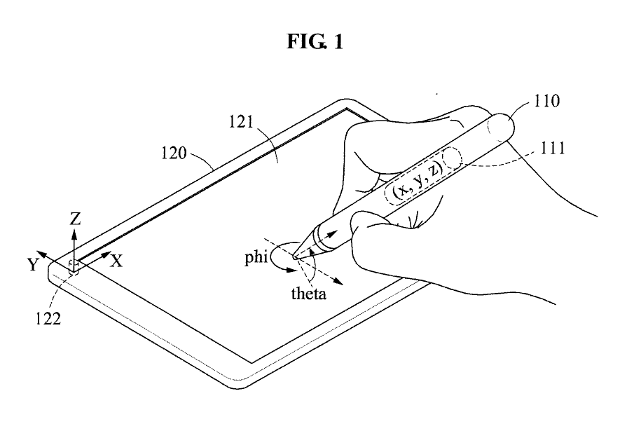

FIG. 1 is a diagram illustrating a terminal and a user input device according to an embodiment.

Referring to FIG. 1, a terminal 120 includes a display 121 and a sensor 122. The sensor 122 may include, for example, a 3-axis magnetic field sensor.

A user input device 110 may make a contact with the display 121. The user input device 110 includes a contactor coming to a contact with the display 121 and a magnetic field generator 111. The magnetic field generator 111 may include a magnet. The user input device 110 may be provided in a form of a pen as illustrated in FIG. 1. The illustrated form of the user input device 110 is provided as an example only, and thus a form of a user input device may not be limited to the form illustrated in FIG. 1. Although an example of the user input device 110 including the magnetic field generator 111 is described herein, such an example is provided as an illustrative example only, and thus the magnetic field generator 111 may be provided in a form of a ring that may be worn by a user.

The sensor 122 may detect a magnetic field to be generated by the magnetic field generator 111. In a case of the terminal 120 including a plurality of sensors, the terminal 120 may determine a location and a direction of the magnetic field generator 111, which correspond to five degrees of freedom (5 DoF). Here, the 5 DoF includes x, y, z, theta, and phi. “Theta” refers to an angle formed between a center of the user input device 110, or a center of the magnetic field generator 111, and a normal of the display 121. “Phi” refers to an angle formed between an x axis of the display 121 and a line to be indicated when the user input device 110 is projected onto the display 121.

For example, when the terminal 120 includes a number of sensors greater than or equal to the 5 DoF of the magnetic field generator 111, the terminal 120 may determine the location and the direction of the magnetic field generator 111 using each sensor value. The sensor values may not be dependent on one another, but independent from one another.

It may not be easy to determine a location and a direction of the user input device 110 or the magnetic field generator 111 having the 5 DoF, in a space, using the sensor 122. Thus, values of theta and phi may be preset. In a case of the values of theta and phi being present, the terminal 120 may determine the location of the user input device 110 having 3 DoF, for example, x, y, and z, using the sensor 122.

The values of theta and phi may be determined based on a hand of the user grabbing the user input device 110. For example, when the user is right-handed, the value of phi may be between 270° and 360° counterclockwise from the x axis. For example, the value of phi may be close to 315°. In addition, the value of theta may be approximately 45°. In a case of the values of theta and phi being preset, the terminal 120 may determine the location corresponding to a DoF of the user input device 110 or the magnetic field generator 111.

In addition, the location of the magnetic field generator 111 in a space may be preset to be a value. In such a case, the terminal 120 may determine the direction of the magnetic field generator 111 or an inclination angle, for example, theta and phi, of the magnetic field generator 111 in a space using a sensor value output from the sensor 122. For example, a location (x, y) of the magnetic field generator 111 on a plane of the terminal 120 may be present to be a value, and the terminal 120 may determine a remaining DoF, for example, z, theta, and phi, using an output value of the sensor 122.

Alternatively, dissimilar to FIG. 1, the user input device 110 may be located on a back side of the terminal 120 or the display 121. When a DoF (theta, phi) of the magnetic field generator 111 is preset to be a value, the terminal 120 may determine the location of the magnetic field generator 111 in a space, for example, a DoF (x, y, z), using the output value of the sensor 122. When a portion of the DoF corresponding to the location of the magnetic field generator 111 is preset to be a value, the terminal 120 may determine the DoF (theta, phi) of the magnetic field generator 111 using the output value of the sensor 122. When the terminal 120 is provided in a virtual reality (VR) terminal, for example, VR goggles, and the user does not manipulate the terminal 120, for example, when the user does not touch the display 121, location information and/or inclination information of the user input device 110 may be input to the terminal 120. Here, the inclination information indicates direction information of the user input device 110 or an inclination angle of the user input device 110 in a space. For example, when a terminal of a smartphone and the like is provided in a VR terminal, for example, VR goggles, and the user does not manipulate the terminal, for example, when the user does not touch a touch screen, a VR may be controlled based on the location information and/or inclination information of the user input device 110. For example, without an input from the user to the terminal 120, it may be possible to control the VR and/or software corresponding to the VR through the user input device 110.

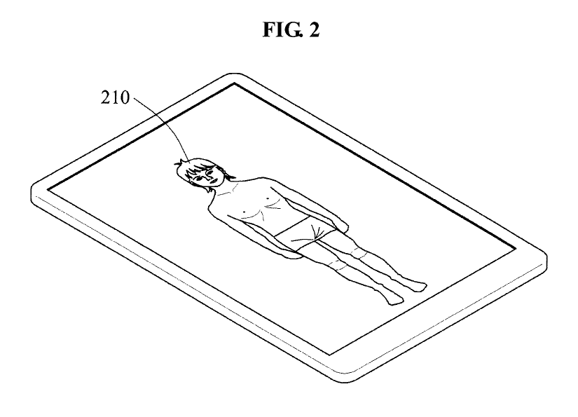

FIGS. 2 through 6 are diagrams illustrating examples of a process of controlling content display according to an embodiment.

Referring to FIG. 2, a content 210 in a human form may be displayed on a display.

The content 210 may include a plurality of layers. An uppermost layer of the content 210 may be displayed on the display. In an example illustrated in FIG. 2, a first layer, which is the uppermost layer of the content 210, may be a skin layer.

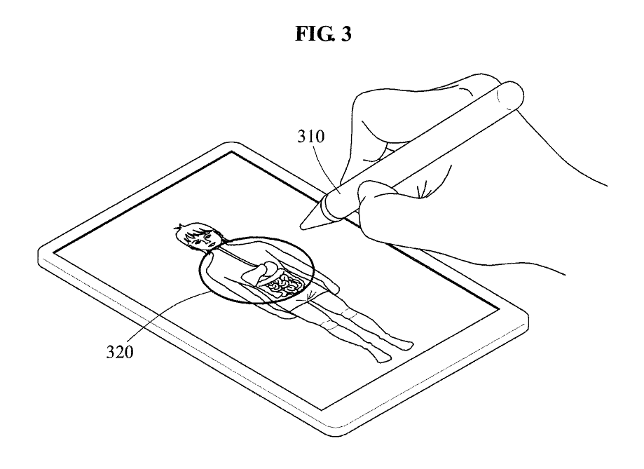

Referring to FIG. 3, a target area 320 of a content may be determined.

When a user input device 310 approaches closer towards a terminal and a distance between the user input device 310 and the terminal is within a first range, the target area 320 or an object to be pointed may be determined based on a location and a direction of the user input device 310. For example, a DoF (x, y, z, theta, phi) of the user input device 310 or a magnetic field generator included in the user input device 310 may be determined, and the target area 320 may be determined based on the determined DoF. According to an example embodiment, a volume corresponding to the user input device 310 may be preset, and the target area 320 may be determined based on the preset volume, and the location and the direction of the user input device 310. A form of the target area 320 may correspond to a cross section of the volume. When the volume corresponding to the user input device 310 is a cone, a cross section of the corn may be a circle. Thus, the form of the target area 320 may be a circle as illustrated in FIG. 3.

When the target area 320 is determined, a second layer of the content may be displayed. A first layer of the content may be displayed prior to the determination of the target area 320, and the second layer under the first layer may be displayed after the target area 320 is determined.

For example, the second layer of the target area 320 may be displayed, and the first layer may be displayed on a remaining area excluding the target area 320. When the target area 320 is determined, the terminal may display the second layer corresponding to the target area 320, and display the first layer on the remaining area excluding the target area 320. As illustrated in FIG. 3, an organ layer under a skin layer of the target area 320 may be displayed, and the skin layer may be displayed on the remaining area excluding the target area 320.

For another example, when the target area 320 is determined, the second layer may overlay the first layer. Here, the terminal may display the second layer corresponding to the target area 320 and display the first layer, in lieu of the second layer, on the remaining area.

For still another example, when the target area 320 is determined and the user input device 310 approaches closer towards the terminal, the terminal may display the second layer corresponding to the target area 320.

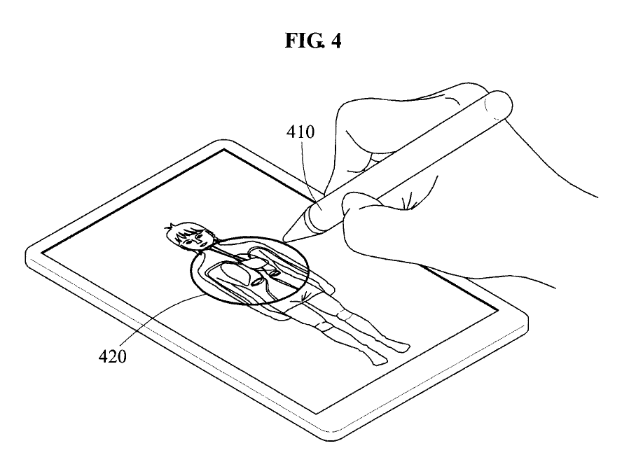

Referring to FIG. 4, a third layer of a content may be displayed on a display.

When a distance between a user input device 410 and a terminal is within a second range, the third layer of the content may be displayed. As illustrated in FIG. 4, a blood vessel layer of a target area 420 may be displayed, and a skin layer may be displayed on a remaining area excluding the target area 420. As described above, the third layer under a second layer of the target area 420 may be displayed. Alternatively, the third layer may overlay the second layer of the content, and the terminal may control the third layer corresponding to the target area 420 to be displayed and a first layer of the content to be displayed on the remaining area excluding the target area 420.

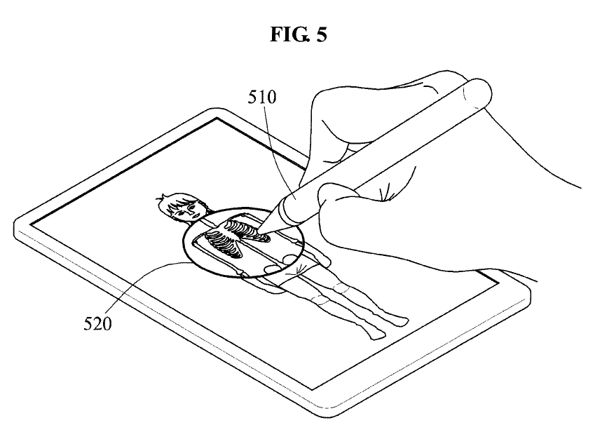

Referring to FIG. 5, a fourth layer of a content may be displayed on a display.

When a distance between a user input device 510 and a terminal is within a third range, the fourth layer of the content may be displayed. As illustrated in FIG. 5, a skeleton layer of a target area 520 may be displayed, and a skin layer may be displayed on a remaining area excluding the target area 520. As described above, the fourth layer under a third layer of the target area 520 may be displayed. Alternatively, the fourth layer may overlay the third layer of the content, and the terminal may control the fourth layer corresponding to the target area 520 to be displayed and a first layer of the content to be displayed on the remaining area excluding the target area 520.

When the user input device 510 moves, the target area 520 may change.

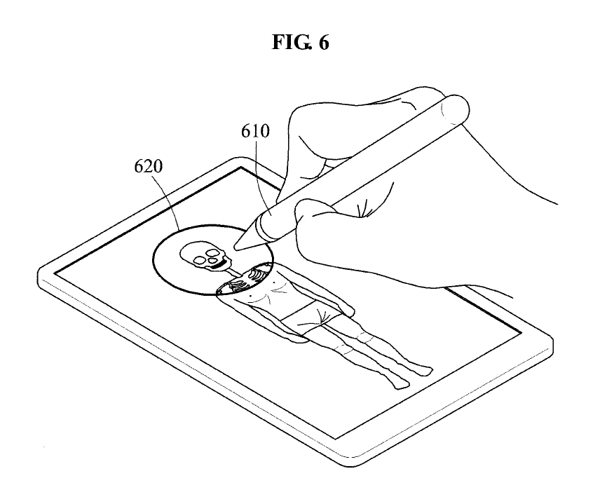

Referring to FIG. 6, when a user input device 610 moves, a target area 620 may change. As illustrated in FIG. 6, the target area 620 may correspond to a face in a content. As described above, the target area 620 may be determined based on a location and a direction of the user input device 610.

Although not illustrated in FIG. 6, the user input device 610 may be separated further from a terminal. Thus, a distance between the user input device 610 and the terminal may deviate from a third range, and be within a second range. In such a case, the terminal may display a third layer, which is an upper layer of a fourth layer.

When the distance between the user input device 610 and the terminal decreases, a lower layer of the content may be displayed. Conversely, when the distance between the user input device 610 and the terminal increases, an upper layer of the content may be displayed.

The details described with reference to FIG. 1 may be applicable to the details described with reference to FIGS. 2 through 6, and thus a more detailed and repeated description will be omitted here.

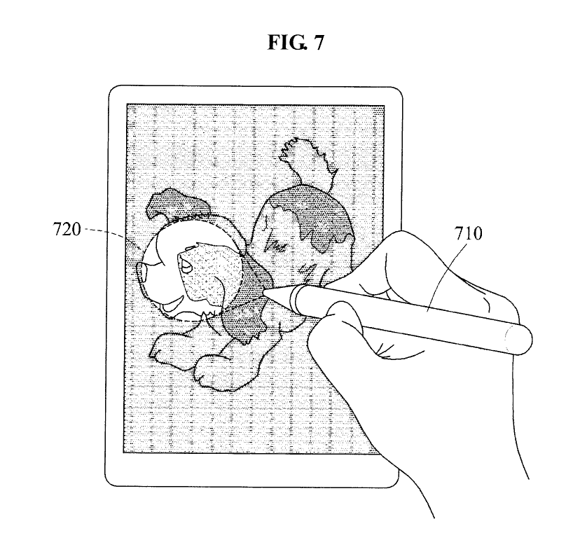

FIGS. 7 through 9 are diagrams illustrating other examples of a process of controlling content display according to an embodiment.

Referring to FIG. 7, a darkened content may be displayed on a display. When a user input device 710 makes a contact with the display, the content may be displayed brightly. In detail, when the user input device 710 makes a contact with the display, a lighting target area 720 and a lighting direction may be determined based on a location and a direction of the user input device 710. Here, the direction may correspond to an inclination angle towards at least one axis, for example, an x axis and a y axis, of the display. The inclination angle may be phi and theta, which are described above. For example, the lighting target area 720 and the lighting direction may be determined based on a location and a direction of a magnetic field generator in a space with respect to a touch point between the user input device 710 and the display. When the lighting target area 720 is determined, an area of the content corresponding to the lighting target area 720 may be displayed brightly. As illustrated in FIG. 7, the area of the content corresponding to the lighting target area 720 may be displayed brightly, and a remaining area of the content excluding the lighting target area 720 may be displayed darkly.

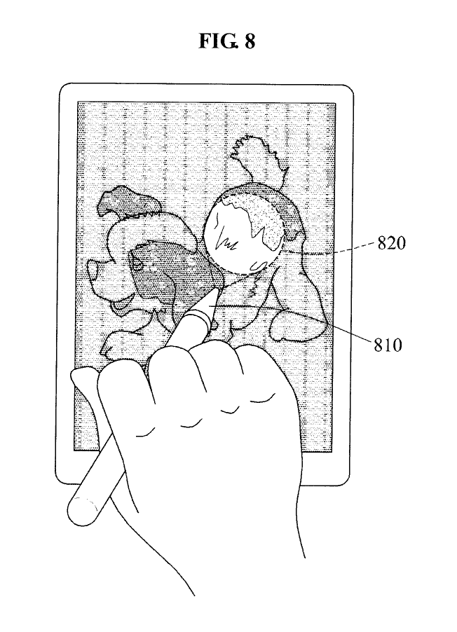

Referring to FIG. 8, a lighting target area 820 and a lighting direction may be differently determined. In detail, as illustrated in FIG. 8, a location and a direction of a user input device 810 in a space may change, and thus the lighting target area 820 and the lighting direction may be determined differently from the example illustrated in FIG. 7. Thus, phi and theta, which are described above, may change and the lighting target area 820 and the lighting direction may be determined differently from the example illustrated in FIG. 7.

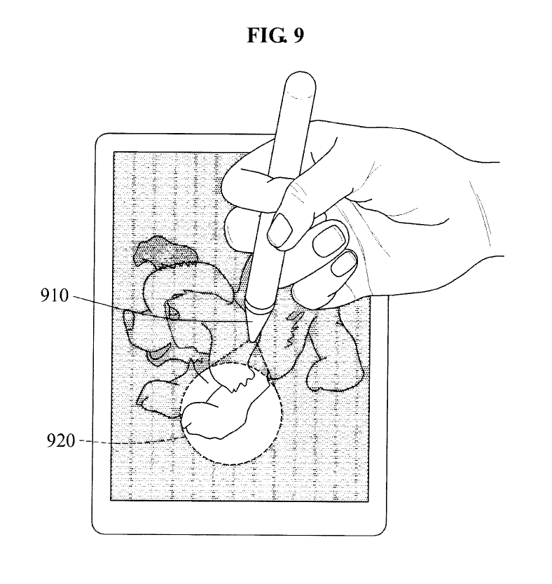

Referring to FIG. 9, a lighting target area 920 and a lighting direction may be determined differently from the examples illustrated in FIGS. 7 and 8. As described above, phi and theta of a user input device 910 may change and the lighting target area 920 and the lighting direction may be determined differently from the examples illustrated in FIGS. 7 and 8.

The details described with reference to FIG. 1 may be applicable to the details described with reference to FIGS. 7 through 9, and thus a more detailed and repeated description will be omitted here.

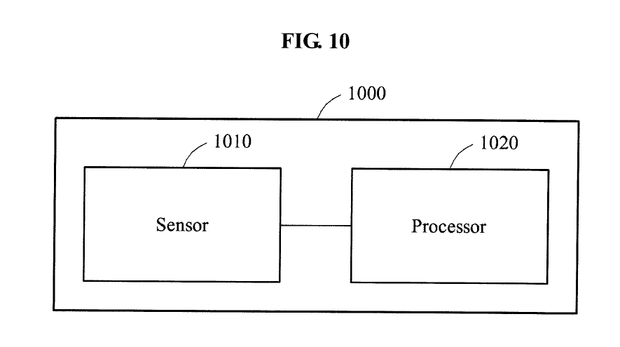

FIG. 10 is a block diagram illustrating a terminal according to an embodiment.

Referring to FIG. 10, a terminal 1000 includes a sensor 1010 and a processor 1020.

The sensor 1010 may sense a location and a direction of an object. Here, the direction may include a direction indicated by the object. The object may be, for example, a finger or a head of a human. Also, as described above, the object may be a user input device. In addition, the object may be a physical device operating autonomously through a battery or a physical device not operating through a battery. The object may be provided as an example, but may not be limited to the aforementioned examples.

According to an example embodiment, the sensor 1010 may measure a magnetic field value corresponding to a DoF of a magnetic field generator based on a magnetic field generated by the magnetic field generator which is physically separated from the terminal 1000. The magnetic field generator may be included in the object or worn on the object. For example, the magnetic field generator may be included in the user input device provided in a form of a pen, which is described above. Alternatively, the magnetic field generator may be provided in a form of a ring, and be worn around a finger of a user.

The sensor 1010 may measure the magnetic field value corresponding to the DoF of the magnetic field generator. For example, the sensor 1010 may measure a magnetic field value corresponding to a DoF (x, y, z, theta, phi) of the magnetic field generator. When respective values of theta and phi are preset, the sensor 1010 may measure a magnetic field value corresponding to a DoF (x, y, z).

Although not illustrated in FIG. 10, the terminal 1000 may further include a communicator. The communicator may receive, from the object, the location and the direction of the object and transfer the received location and direction to the processor 1020. For example, the object may include a camera, and measure a relative location and direction of the object to the terminal 1000 using the camera. Here, the object may measure a distance from the terminal 1000, and transfer the measured distance to the terminal 1000. For another example, the object may include a magnetic field sensor. The object may measure a magnetic field value based on a magnetic field generated by the terminal 1000, and determine the location and direction of the object based on the magnetic field value. The object may transmit information about the location and the direction of the object to the terminal 1000.

The processor 1020 may control at least one of content display and power saving for the terminal 1000 based on the information about the location and the direction of the object. Here, the information about the location and the direction of the object may be output from a sensor embedded in the terminal 1000 or received from the object. For example, the processor 1020 may control at least one of the content display and the power saving based on the magnetic field value. For another example, the processor 1020 may verify whether a physical portion of a body moves towards the terminal 1000 or views (or looks at) the terminal 1000 based on a location of the physical portion and a direction indicated by the physical portion, and control at least one of the content display and the power saving based on the verifying.

Hereinafter, controlling content display and controlling power saving will be described in detail.

<Control of Content Display>

The processor 1020 may determine a target area of a content displayed on a display of the terminal 1000 based on at least one of the location information and the direction information of the object. Here, when a volume corresponding to the object is preset, the processor 1020 may determine the target area based on the location information and the direction information of the object and the volume. A form of the target area may be determined based on the volume.

According to an example embodiment, when the target area is determined, the processor 1020 may expose a subsequent layer of a displayed layer of the target area. For example, a first layer, which is an uppermost layer of the content, may be displayed on the display, and the target area of the content may be determined. In such an example, a second layer, which is a lower layer of the first layer of the target area, may be exposed. The first layer may be displayed on a remaining area excluding the target area. Alternatively, when the target area is determined, the processor 1020 may expose the second layer. Here, the processor 1020 may visually expose the second layer corresponding to the target area, and allow the second layer not to be visually exposed to the remaining area excluding the target area.

For example, when a content in a form of a human is displayed on the display, a skin layer, an organ layer, a blood vessel layer, and a skeleton layer of the human may be displayed based on location information and direction information of the magnetic field generator. When a distance between the object and the terminal 1000 is a first distance while the skin layer is being displayed on the display, a target area of the content may be determined. When the target area is determined, the processor 1020 may expose the organ layer located under the skin layer of the target area, and expose the skin layer on a remaining area excluding the target area. When the object approaches closer towards the terminal 1000 and the distance between the object and the terminal 1000 becomes a second distance, the processor 1020 may expose the blood vessel layer of the target area. When the distance between the object and the terminal 1000 becomes a third distance, the processor 1020 may expose the skeleton layer of the target area. When the object comes closer to the terminal 1000, the skin layer, the organ layer, the blood vessel layer, and the skeleton layer of the content may be sequentially displayed. That is, the layers of the target area may be sequentially exposed based on a change in a DoF of the object.

The processor 1020 may control an exposure of the target area determined based on at least one of the location information and the direction information of the object and on the volume preset to correspond to the object. According to an example embodiment, the content may include three-dimensional (3D) information. For example, the content may include volume data. The volume data may include x-axis information, y-axis information, and z-axis information.

The 3D information of the content corresponding to the location of the object in a space may be exposed. For example, when the content includes voxel data of a brain, the voxel data of a location of the brain corresponding to the location of the object in as space may be displayed. When the object comes closer to the terminal 1000, an inner portion of the content may be exposed to the display.

The volume corresponding to the object may be determined, and a form in which the content including the 3D information is holed by the volume may be visually displayed. For example, a watermelon-shaped content may be displayed on the display, and a volume corresponding to the object may be a cone. In such an example, when a distance between the object and the terminal 1000 is a first distance, a target area may be determined. When the target area is determined, the processor 1020 may control an exposure of the target area based on a depth corresponding to the first distance and a form corresponding to the cone. That is, visibility of the target area may be controlled and the target area may be displayed as disappearing. That is, a hole having the depth corresponding to the first distance and the form corresponding to the cone may be created in the content. Thus, an inner portion of the content may be visually displayed on the display. When the object comes closer to the terminal 1000 and the distance between the object and the terminal 1000 becomes a second distance, the exposure of the target area may be controlled based on a depth corresponding to the second distance and the form corresponding to the cone. Thus, when the object comes closer to the terminal 1000, a deeper portion of a watermelon may be displayed on the display.

According to an example embodiment, when the target area is determined, the processor 1020 may control a visual feedback on the content to correspond to a moving direction of the object based on a selection input for the target area. When the object comes closer to the terminal 1000 after the target area is selected, the processor 1020 may expose a visual feedback of pushing the content. Conversely, when the object is separated further from the terminal 1000 after the target area is selected, the processor 1020 may expose a visual feedback of pulling the content.

For example, a door-shaped content may be displayed on the display and a door may be opened forward the display, and a doorknob of the door-shaped content may be determined to be a target area. In such an example, when the object comes closer to the terminal 1000 and a distance between the object and the terminal 1000 is a first distance, the doorknob of the door-shaped content may be determined to be the target area. Here, a selection input for the doorknob may occur. When the object points at the doorknob and the pointing is maintained for a preset period of time, the selection input for the doorknob may occur. When the target area is determined and a substantial change in a DoF of the object, for example, a change in the location information and the direction information, does not occur, the processor 1020 may select the target area. Alternatively, the selection input for the doorknob may occur based on an input of pressing a button provided in the object. Alternatively, the selection input for the doorknob may occur based on a touch input to the display.

When the object comes closer to the terminal 1000 while the selection input for the doorknob occurs, a visual effect of closing the door in a moving direction of the object may be displayed on the display. Conversely, when the object is separated further from the terminal 1000, a visual effect of opening the door in a moving direction of the object may be displayed on the display. That is, a push input corresponding to the moving direction of the object may be possible. Similarly, a pull input corresponding to the moving direction of the object may be possible.

For another example, a plurality of people may be displayed as a content on the display. When a selection input for one of the people is made, the processor 1020 may control a visual feedback on the selected person based on a moving direction of the object. When the object comes closer to the terminal 1000, the processor 1020 may expose a visual feedback corresponding to the moving direction of the object. Here, the visual feedback may be a visual effect of pushing the selected person backwards. When the object is separated further from the terminal 1000, the processor 1020 may expose a visual feedback corresponding to the moving direction of the object. Here, the visual feedback may be a visual effect of raising the fallen person up.

According to an example embodiment, when a touch event occurs based on a contact between the object and the terminal 1000, the processor 1020 may determine a lighting target area and a lighting direction of a content based on a location at which the touch event occurs and an inclination angle of the object towards the terminal 1000.

For example, when a darkened content is displayed on the display and a touch event occurs from a contact between the object and the display, the processor 1020 may determine the lighting target area and the lighting direction based on a location at which the touch event occurs and a DoF (theta, phi) of the object.

For example, when a character in a content enters a cave and the content is darkened, a lighting target area and a lighting direction may be determined based on a contact point between the object and the terminal 1000 and a DoF (theta, phi) of the object. Thus, the lighting target area may be displayed brightly.

According to an example embodiment, the processor 1020 may control visibility of a content based on at least one of the location information and the direction information of the object. When the object comes closer to the terminal 1000, the content may be displayed transparently or clearly.

Although the control of the content display is described above based on the location information and/or the direction information of the object, the description of the control is provided as an illustrative example only. Thus, controlling content display based on location information and/or direction information of an object may be possible. For example, the object may include a camera, and verify a relative location to the terminal 1000 through the camera. Alternatively, the object may include a microphone, and verify a relative location to the terminal 1000 using a sound wave, for example, ultrasonic waves, output from the terminal 1000. The object may transmit the relative location to the terminal 1000, and the terminal 1000 may control the content display using the received location. For another example, the terminal 1000 may include a camera, and verify a location of the object in a space through the camera. Alternatively, the terminal 1000 may include a microphone and receive a sound wave, for example, ultrasonic waves, output from the object through the microphone. The terminal 1000 may verify the location of the object in a space using the sound wave. The terminal 1000 may control the content display based on the verified location.

<Control of Power Saving>

The processor 1020 may verify a relative location of the object to the terminal 1000. For example, the processor 1020 may verify a distance between the object and the terminal 1000. Here, when the relative location of the object or the distance between the object and the terminal 1000 is out of a preset range, the processor 1020 may enter a power saving mode. For example, when the object is located above the display by a distance greater than a preset distance, the processor 1020 may control the display to enter a power saving mode, for example, a sleep mode. According to an example embodiment, a 3D space above the display may be defined as a motion space region, and the processor 1020 may enter the power saving mode when the user input device or the object included in the user input device is not located in the motion space region.

The processor 1020 may verify an inclination angle of the user input device towards the terminal 1000 and enter the power saving mode based on the inclination angle. For example, when the user does not use the user input device, the user may place the user input device on the display. In such an example, the user input device may be located in parallel to the display and a value of theta may be 0. The processor 1020 may enter the power saving mode when a DoF, for example, theta, of the object is 0.

The processor 1020 may enter the power saving mode based on a magnetic field value changing pattern. When the object is not used, a change in a magnetic field value may be sufficiently small. In such a case, the processor 1020 may enter the power saving mode because the magnetic field value changing pattern may be small or insufficient.

According to an example embodiment, location information of a user input device may be determined through the user input device including a simple permanent magnet and at least one magnetic field sensor included in a terminal, without an addition of a communication device such as an expensive sensor, a processor, and Bluetooth, and/or a power supply. The determined location information may be used to allow the terminal to turn off a display output and to enter a power saving mode. Thus, an amount of power consumption of the terminal may be reduced.

According to an example embodiment, a sensor, for example, a magnetic field sensor and a camera, may measure a location and/or a direction of a stylus pen or a finger with respect to the terminal, and the terminal may determine whether a user intends to input data based on a result of the measuring. When the terminal determines that the user does not intend to input data, the terminal may enter the power saving mode. Thus, an amount of power consumption of the terminal may be reduced.

According to an example embodiment, whether to enter the power saving mode may be more accurately determined by measuring a location of a hand or a pen used by the user to input data using the magnetic field sensor, instead of using an existing power saving method of detecting whether the user views (or looks at) the terminal using a camera and computer vision technology. In such an existing power saving method, power may also be consumed for using the camera and determining whether the user views the camera. However, according to an example embodiment, using the location of the pen, power of the terminal may be consumed less. In addition, based on the location and/or the direction of the pen, a content on a display of the terminal may be darkened or clouded to prevent another person from viewing the content on the display. Thus, security of the content and privacy of the user may be secured.

According to an example embodiment, the object may include a camera, and verify a relative location to the terminal through the camera. For example, the object may verify a distance between the object and the terminal. Also, the object may include a microphone, and verify a relative location to the terminal using a sound wave, for example, ultrasonic waves, output from the terminal. The object may transmit, to the terminal, the relative location of the object to the terminal, and the terminal may control power saving using the relative location received from the object. Alternatively, the terminal may include a camera, and verify a location of the object in a space through the camera. Also, the terminal may include a microphone and receive a sound wave, for example, ultrasonic waves, output from the object. The terminal may verify the location of the object in a space using the received sound wave. The terminal may control the power saving based on the verified location.

According to an example embodiment, when a touch event occurs based on a contact between the object and the terminal 1000, the processor 1020 may control an exposure of a layer of a content displayed on the display using information about a pressure of the touch event. For example, when a first layer of the content is displayed on a touch screen, and a first touch input is made to the touch screen of the terminal 1000, the processor 1020 may expose a second layer of the content based on information about a pressure of the first touch input. When a second touch input is made while the second layer is being exposed, the processor 1020 may determine whether a pressure of the second touch input is sufficient to a layer change. When the pressure of the second touch input is determined to be sufficient to the layer change, the processor 1020 may expose a thirst layer of the content. Based on a pressure of a touch input, visibility of a layer of the content may be controlled.

According to an example embodiment, the terminal 1000 may further include a sensor configured to measure a pressure of a touch event, and the sensor may output information about the pressure of the touch event to the processor 1020. The processor 1020 may control an exposure of a layer of the content based on the information output from the sensor. Also, the object may include a sensor configured to measure a pressure of a touch event, and may transmit information about the pressure of the touch event to the terminal 1000 when the touch event occurs. The processor 1020 may control an exposure of a layer of the content using the information received from the object.

The details described with reference to FIGS. 1 through 9 may be applicable to the details described with reference to FIG. 10, and thus a more detailed and repeated description will be omitted here.

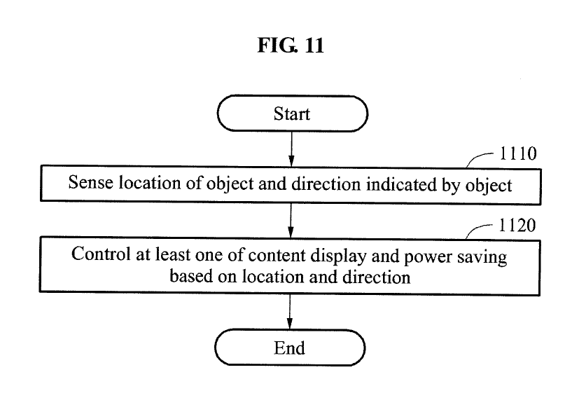

FIG. 11 is a flowchart illustrating an operating method of a terminal according to an embodiment.

Referring to FIG. 11, in operation 1110, the terminal senses a location of an object and a direction indicated by the object. Although not illustrated in FIG. 11, the object may sense the location and the direction of the object and transmit a result of the sensing to the terminal.

In operation 1120, the terminal controls at least one of content display and power saving based on the location and the direction of the object.

The details described with reference to FIGS. 1 through 10 may be applicable to the details described with reference to FIG. 11, and thus a more detailed and repeated description will be omitted here.

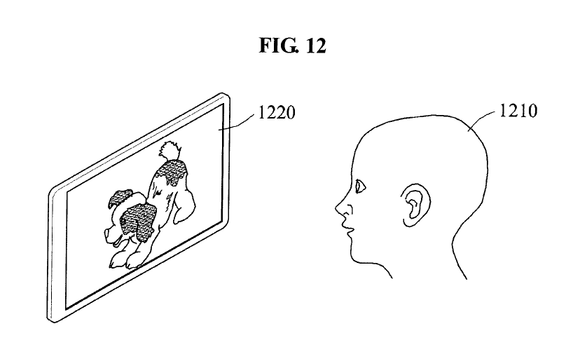

FIG. 12 is a diagram illustrating an example of an operating method of a terminal according to an embodiment.

According to an example embodiment, an object may be a human face.

Referring to FIG. 12, a user 1210 of a terminal 1220 may view the terminal 1220. The terminal 1220 may verify whether a face or eyes of the user 1210 view (or look at) a display of the terminal 1220, and verify which portion of the display the user 1210 views and verify a viewing distance when the user 1210 is verified to view the display of the terminal 1220. For example, the terminal 1220 may include a camera and/or a depth sensor, and verify whether the face or the eyes of the user 1210 view the display of the terminal 1220 through head tracking and/or eye tracking. When the face or the eyes of the user 1210 are verified to view the display of the terminal 1220, the terminal 1220 may not enter a power saving mode, and may control a content to be displayed on the display of the terminal 1220 by referring to a location at which the eyes of the user 1210 stays on the display of the terminal 1220 and a distance between the eyes of the user 1210 and the terminal 1220.

The details described with reference to FIGS. 1 through 11 may be applicable to the details described with reference to FIG. 12 under assumption that a face or an eye of a user is an object, and thus a more detailed and repeated description will be omitted here.

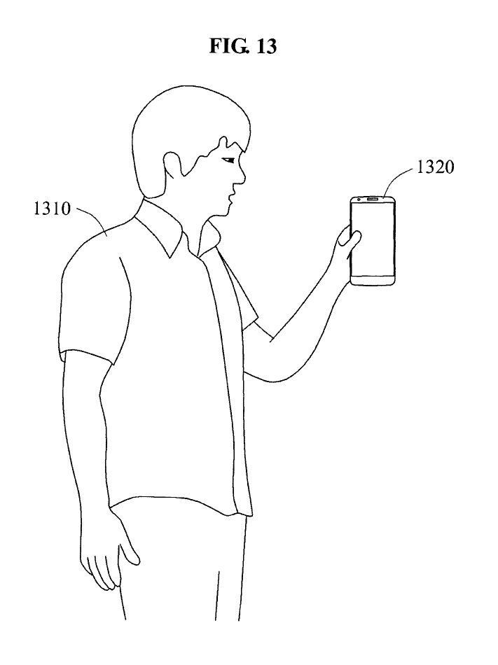

FIG. 13 is a diagram illustrating another example of an operating method of a terminal according to an embodiment.

Referring to FIG. 13, a user 1310 may view (or look at) a terminal 1320.

The terminal 1320 may verify whether an eye or a face of the user 1310 comes closer to or is separated further from a display of the terminal 1320, and control content display based on the verifying. For example, although the terminal 1320 does not move, the face of the user 1310 may come closer to or be separated further from the display. In such an example, the terminal 1320 may verify whether the face of the user 1310 comes closer to or is separated further from the display using a camera and/or a depth sensor. Also, although the face of the user 1310 does not move, the terminal 1320 may come closer to or be separated further from the face of the user 1310. In such an example, the terminal 1320 may verify whether the face of the user 1310 comes closer to or is separated farther from the display using an accelerometer, a gyroscope, and/or a geomagnetic sensor, which are embedded in the terminal 1320.

When the face of the user 1310 and the terminal 1320 come closer to each other, and the face or the eye of the user 1310 views a portion of the display, the terminal 1320 may control an exposure of a layer of a content to be displayed on the display. For example, the terminal 1320 may expose a second layer of the content when the face of the user 1310 and the terminal 1320 comes closer to each other while a first layer of the content is being displayed on the display of the terminal 1320. The controlling of a layer is described above, and thus a more detailed and repeated description will be omitted here for brevity.

In addition, when the face of the user 1310 and the terminal 1320 come closer to each other, a lighting target area and a lighting direction may be determined and the lighting target area of a darkened content may be displayed brightly.

Further, when the face of the user 1310 and the terminal 1320 come closer to each other, the terminal 1320 may expose a visual feedback of pushing a content to be displayed. Conversely, when the face of the user 1310 and the terminal 1320 are separated further from each other, the terminal 1320 may expose a visual feedback of pulling the content.

The terminal 1320 may control visibility and lighting of the content, and/or as visual effect corresponding to a push and a pull of the content based on a distance between a physical portion and the display of the terminal 1320, a direction indicated by the physical portion, and/or a moving direction of the physical portion. In addition, the terminal 1320 may zoom in or out the content to be displayed on the display based on the distance between the physical portion and the display of the terminal 1320.

The details described with reference to FIGS. 1 through 11 may be applicable to the details described with reference to FIG. 13, and thus a more detailed and repeated description will be omitted here.

According to example embodiments, a location and a direction of a stylus pen or a finger with respect to a terminal may be measured through a sensor. When a user is determined not to intend, to use the terminal based on a result of the measuring, the terminal may enter a power saving mode to reduce an unnecessary amount of power consumption. Further, according to example embodiments, a visual effect of a content may be controlled through an interaction between the terminal and a user input device.

The apparatus and the units described herein according to example embodiments may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network coupled computer systems so that the software is stored and executed in a distributed fashion. The software and data may be stored by one or more non-transitory computer-readable recording media.

The method described herein according to example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A terminal, comprising:
a processor configured to control at least one of content display and power saving for the terminal based on a location of an object and a direction indicated by the object.

2. The terminal of claim 1, further comprising:
a first sensor configured to measure a magnetic field value corresponding to a location and a direction of a magnetic field generator based on a magnetic field generated from the magnetic field generator corresponding to the object, and
wherein the processor is configured to control at least one of the content display and the power saving based on the magnetic field value.

3. The terminal of claim 1, wherein the object comprises a physical portion, and further comprising:
a second sensor configured to sense a location of the physical portion and a direction indicated by the physical portion, and
wherein the processor is configured to verify whether the physical portion moves towards the terminal or views the terminal based on the location of the physical portion and the direction indicated by the physical portion, and control at least one of the content display and the power saving based on the verifying.

4. The terminal of claim 1, further comprising:
a communicator configured to receive the location and the direction from the object, and
wherein the processor is configured to control at least one of the content display and the power saving based on the received location and the received direction.

5. The terminal of claim 1, wherein the processor is configured to determine a target area of a content displayed on a display of the terminal based on at least one of the location and the direction.

6. The terminal of claim 5, wherein the processor is configured to expose a subsequent layer of a displayed layer of the target area based on the determining of the target area.

7. The terminal of claim 5, wherein a form of the target area is determined based on a volume corresponding to the object.

8. The terminal of claim 1, wherein, when a target area of a content is determined based on at least one of the location and the direction, the object moves towards the terminal, and a distance between the object and the terminal is within a preset range, the processor is configured to expose a subsequent layer located under a displayed layer of the target area.

9. The terminal of claim 1, wherein the processor is configured to control an exposure of a target area determined based on at least one of the location and the direction and on a volume preset to correspond to the object.

10. The terminal of claim 1, wherein the processor is configured to determine a target area of a content based on at least one of the location and the direction, and control a visual feedback on the content to correspond to a moving direction of the object based on a selection input for the target area.

11. The terminal of claim 10, wherein the processor is configured to expose a visual feedback of pushing the content in response to the object coming closer to the terminal after the target area is selected, and expose a visual feedback of pulling the content in response to the object being separated further from the terminal after the target area is selected.

12. The terminal of claim 1, wherein, in response to occurrence of a touch event based on a contact between the object and the terminal, the processor is configured to determine a lighting target area and a lighting direction of a content based on a location at which the touch event occurs and an inclination angle of the object towards the terminal.

13. The terminal of claim 1, wherein, in response to occurrence of a touch event based on a contact between the object and the terminal, the processor is configured to control an exposure of a layer of a content displayed on a display using information about a pressure of the touch event.

14. The terminal of claim 1, wherein the processor is configured to verify a relative location of the object to the terminal, and enter a power saving mode in response to the relative location being out of a preset range.

15. The terminal of claim 1, wherein the processor is configured to verify an inclination direction of the object towards the terminal, and enter a power saving mode based on the inclination direction.

16. The terminal of claim 1, wherein the processor is configured to enter a power saving mode based on a magnetic field value changing pattern.

17. The terminal of claim 2, wherein, when a degree of freedom (DoF) corresponding to the location is preset, the processor is configured to determine a direction corresponding to an inclination of the object in a space using the magnetic field value.

18. An operating method of a terminal, comprising:
controlling at least one of content display and power saving based on a location of an object and a direction indicated by the object.
